(19) United States
(12) Patent Application Publication
(10) Pub. No.: US 2007/0008075 A1
(43) Pub. Date: Jan. 11, 2007

(54) Signal coupling device

(75) Inventor: Tetsuro Shimomura, Tokyo (JP)

Correspondence Address: BUCHANAN, INGERSOLL & ROONEY PC, POST OFFICE BOX 1404, ALEXANDRIA, VA, 22313-1404, US

(73) Assignee: MITSUBISHI DENKI KABUSHIKI KAISHA, Tokyo (JP)

(21) Appl. No.: 11/349,195

(22) Filed: Feb. 8, 2006

(30) Foreign Application Priority Data
Jun. 17, 2005 (JP) 2005-178054

(51) Int. Cl. G05B 11/01

(52) U.S. Cl. 340/310.11

(57) ABSTRACT

Provided is a signal coupling device which suppresses the leakage of magnetic field to the outside from a signal line connecting between a PLC modem and the signal coupling device, thereby reducing the influence of such magnetic field leakage on wireless equipment in the vicinity thereof. The signal coupling device includes: a signal coupling member having a hollow portion through which a power line penetrates; and a signal line covered with an insulating coating, the signal line having a penetrating portion penetrating through the hollow portion, and a first transmission portion and a second transmission portion which connect the opposite ends of the penetrating portion to the modem to thereby transmit a PLC signal. The first transmission portion and the second transmission portion are arranged not coaxially but at a predetermined spacing from each other.

### BACKGROUND OF THE INVENTION

1. Field of the Invention

The present invention relates to a signal coupling device for coupling a high-frequency signal for power line communication (PLC) to an electric circuit.

2. Description of the Related Art

For the power line communication as described above, there is used a modem for power line communication (hereinafter referred to as “PLC modem”). In conventional signal coupling devices, the PLC modem and the signal coupling device are connected to each other by a coaxial cable, and a PLC signal is bidirectionally transferred between a power line and the modem (refer to, for example, JP 10-504948 A).

In conventional signal coupling devices, a magnetic field is induced in the outer shield portion of a coaxial feed line by means of an electric current flowing in a direction opposite to the direction of a signal in a central portion of a coaxial signal line, so a signal passing through the central conductor of the coaxial feed line cancels out the magnetic field generated, thereby suppressing the leakage of magnetic filed to the outside of the coaxial signal line. At the same time, the generated magnetic field is shielded by the outer shield portion of the coaxial feed line to suppress leakage thereof.

However, it is difficult to achieve perfect symmetry of the configurations of the central conductor and outer covering shield portion, which makes it difficult to achieve shielding of magnetic field by the outer shield portion. Further, a magnetic field is generated outside of the outer shield portion due to current flowing in the outer shield portion.

Since power line communication uses, for example, a high-frequency signal whose frequency falls within a 2 to 30 MHz band or KHz band, a magnetic field leaking to the outside of the signal coupling device causes interfering electric waves to be exerted on wireless equipment located in the vicinity of the signal coupling device. When, in order to overcome this problem, the output of the PLC modem is lowered to thereby reduce the magnetic field leakage from the signal line connecting between the signal coupling device and the PLC modem, the strength of the PLC signal weakens so the range of possible PLC communication becomes narrow.

### SUMMARY OF THE INVENTION

The present invention has been made with a view to solving the above-mentioned problems, and therefore it is an object of the present invention to provide a signal coupling device with which the leakage of magnetic field from a signal line connecting between a PLC modem and a signal coupling device to the outside thereof is suppressed to thereby reduce the influence of such magnetic field leakage on wireless equipment located in the vicinity of the signal line.

A signal coupling device according to the present invention includes: a signal coupling member having a hollow portion through which a power line penetrates; and a signal line covered with an insulating coating, the signal line having a penetrating portion that penetrates through the hollow portion, and a first transmission portion and a second transmission portion which extend from the penetrating portion. The first transmission portion and the second transmission portion are arranged at a predetermined spacing from each other.

Since the signal coupling device according to the present invention includes: the signal coupling member having a hollow portion through which the power line penetrates; and the signal line covered with an insulating coating, the signal line having the penetrating portion that penetrates through the hollow portion, and the first transmission portion and the second transmission portion extending from the penetrating portion and being arranged at a predetermined spacing from each other, the magnetic field intensity at a position distant from the first transmission portion and the second transmission portion is thus extremely small due to the canceling of magnetic fields. Accordingly, it is possible to reduce leakage of magnetic field to the outside of the region including the first transmission portion, the second transmission portion, and the space therebetween, whereby the influence of Electromagnetic Compatibility (EMC) or the like on surrounding wireless equipment can be reduced.

### BRIEF DESCRIPTION OF THE DRAWINGS

In the accompanying drawings:

FIG. 1 is a diagram showing a state where a PLC modem is connected to a signal coupling device according to Embodiment 1 of the present invention;

FIG. 2 is a diagram showing the wiring structure of a PLC signal line in the signal coupling device according to Embodiment 1 of the present invention, together with the sectional structures of the signal coupling device and power line;

FIG. 3 is a diagram conceptually illustrating magnetic fields generated by the PLC signal line of the signal coupling device according to Embodiment 1 of the present invention;

FIG. 4 is a diagram showing the wiring structure of a PLC signal line in a signal coupling device according to Embodiment 2 of the present invention, together with the sectional structures of the signal coupling device and power line;

FIG. 5 is a diagram conceptually illustrating magnetic fields generated by the PLC signal line of the signal coupling device according to Embodiment 2 of the present invention;

FIG. 6 is a diagram showing the wiring structure of a PLC signal line in a signal coupling device according to Embodiment 3 of the present invention, together with the sectional structures of the signal coupling device and power line;

FIG. 7 is a diagram showing the wiring structure of a PLC signal line in a signal coupling device according to Embodiment 4 of the present invention, together with the sectional structures of the signal coupling device and power line;

FIG. 8 is a diagram showing the wiring structure of a PLC signal line in a signal coupling device according to Embodiment 5 of the present invention, together with the sectional structures of the signal coupling device and power line;

FIG. 9 is a diagram conceptually illustrating magnetic fields generated by the PLC signal line of the signal coupling device according to Embodiment 5 of the present invention;

FIG. 10 is a diagram conceptually illustrating magnetic fields generated by a PLC signal line of a signal coupling device according to Embodiment 6 of the present invention;

FIG. 11 is a sectional diagram conceptually illustrating magnetic fields generated by the PLC signal line of the signal coupling device according to Embodiment 6 of the present invention;

FIG. 12 is a diagram schematically showing the structure of a holder for holding a PLC signal line of a signal coupling device according to Embodiment 7 of the present invention;

FIG. 13 is a diagram schematically showing the structure and main portions of a holder for holding a PLC signal line of a signal coupling device according to Embodiment 8 of the present invention;

FIGS. 14A through 14C are diagrams schematically showing the structure and main portions of the holder for holding the PLC signal line of the signal coupling device according to Embodiment 8 of the present invention; and

FIG. 15 is a diagram schematically showing the structure and main portions of the holder for holding the PLC signal line of the signal coupling device according to Embodiment 8 of the present invention.

### DESCRIPTION OF THE PREFERRED EMBODIMENTS

### Embodiment 1

Hereinbelow, a signal coupling device according to Embodiment 1 of the present invention will be described with reference to the drawings.

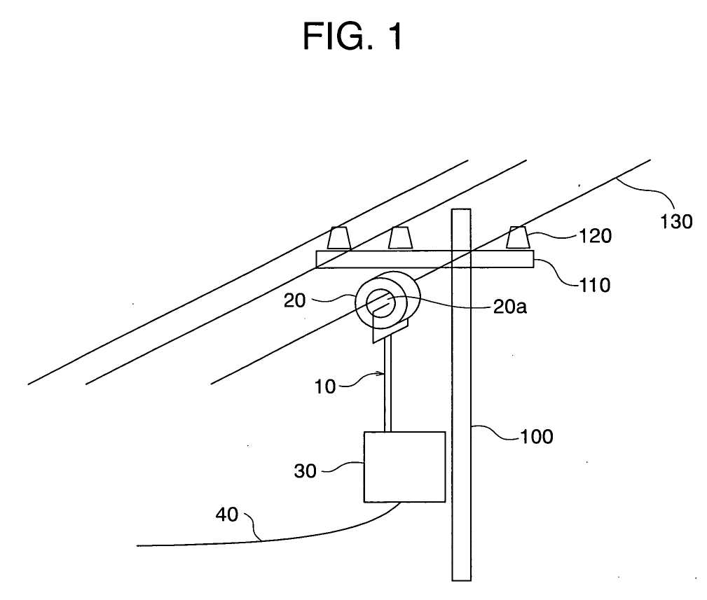

FIG. 1 is a diagram showing a state where a PLC modem is connected to the signal coupling device according to Embodiment 1 of the present invention.

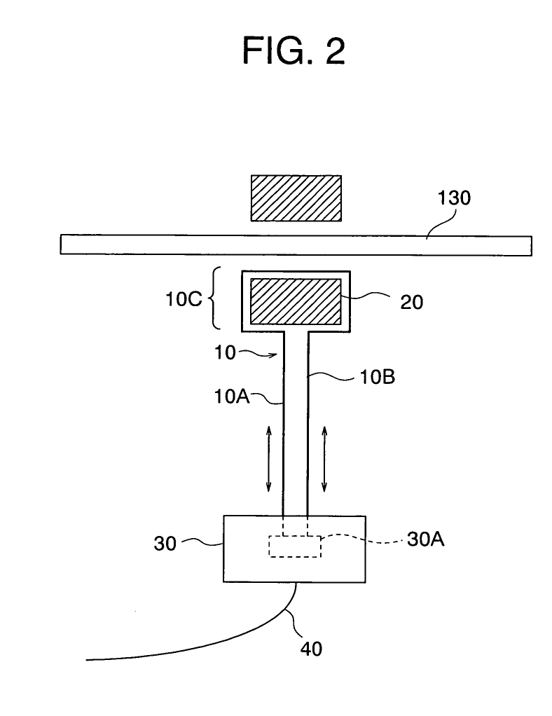

FIG. 2 is a diagram showing the wiring structure of a PLC signal line in the signal coupling device according to Embodiment 1 of the present invention, together with the sectional structures of the signal coupling device and power line.

As shown in FIG. 1, the signal coupling device according to Embodiment 1 of the present invention is an inductive coupling unit including an inductive coupling member 20 and a PLC signal line 10 for transferring a PLC signal between a power line 130 and a PLC modem 30.

Further, a plurality of power lines 130 are suspended from a power pole 100 through support insulators 120.

The signal coupling member 20 is an annular member having a hollow portion 20a through which the PLC signal line 10 and the power line 130 penetrate.

The signal coupling member 20 is formed of a magnetic material such as ferrite and performs signal coupling by electromagnetic induction action between the power line 130 and the PLC signal line 10, with power line 130 serving as a primary winding and the PLC signal line 10 serving as a secondary winding.

Further, connected to the PLC modem 30 is a media signal line 40 for communicating signals used for internet or telephone communication between user terminals (not shown) and the PLC modem 30.

As shown in FIG. 2, the PLC signal line 10 is composed of a first transmission portion 10A, a second transmission portion 10B, and a penetrating portion 10C.

The penetrating portion 10C is a portion located between the first transmission portion 10A and the second transmission portion 10B, which are linearly shaped, and, at its central portion, the penetrating portion 10C penetrates through the hollow portion 20a of the signal coupling member 20. The first transmission portion 10A and second transmission portion 10B, each serving to transmit the PLC signal, are connected to the opposite end portions of the penetrating portion 10C. The first transmission portion 10A and the second transmission portion 10B, which are arranged in parallel at a predetermined spacing from each other, are connected to a signal transformer 30A of the PLC modem 30. The first transmission portion 10A and the second transmission portion 10B are connected to each other inside the signal transformer 30A.

As described above, the PLC signal line 10 forms a closed circuit between the signal coupling member 20 and the PLC modem 30.

Although in the example shown in FIG. 2 the penetrating portion 10C penetrates the hollow portion 20a of the signal coupling member 20 once, the penetrating portion 10C may be wound in the manner of a coil between the first transmission portion 10A and the second transmission portion 10B so as to penetrate through the hollow portion 20a multiple times.

While the direction of current flowing in the PLC signal line 10 is not constant since the power line 130 and the PLC modem 30 transfer the PLC signal therebetween, the direction of current flowing in the first transmission portion 10A and the direction of current flowing in the second transmission portion 10B are always opposite to each other.

It should be noted as a matter of course that the first transmission portion 10A, the second transmission portion 10B, and the penetrating portion 10C are each covered with an insulating coating.

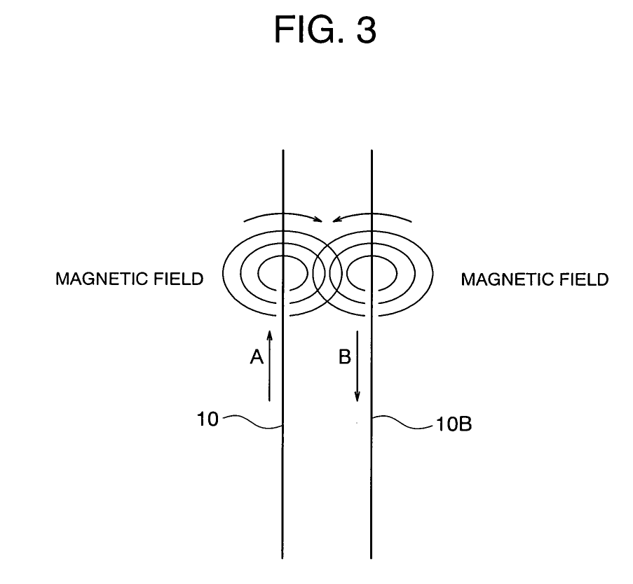

FIG. 3 is a diagram conceptually illustrating magnetic fields generated by the PLC signal line of the signal coupling device according to Embodiment 1 of the present invention.

Provided that the directions of currents flowing in the first transmission portion 10A and in the second transmission portion 10B upon transmission of the PLC signal are as indicated by the arrows A and B shown in FIG. 3, respectively, according to Fleming's right-hand rule, the magnetic fields generated by the respective parallel-arranged parts of the first transmission portion 10A and second transmission portion 10B act in opposite directions with the first transmission portion 10A and the second transmission portion 10B taken as the center.

For this reason, the magnetic field intensity at a position distant from the first transmission portion 10A and the second transmission portion 10B is extremely small because the magnetic fields cancel each other. At a position distant from the PLC signal line 10, the magnetic fields generated by the first transmission portion 10A and by the second transmission portion 10B cancel each other more efficiently as the distance between the first transmission portion 10A and the second transmission portion 10B becomes smaller.

Accordingly, it is possible to suppress magnetic field leakage to the outside of the region including the first transmission portion 10A, the second transmission portion 10B, and the space therebetween, whereby the influence of Electromagnetic Compatibility (EMC) on surrounding wireless equipment can be reduced.

While the magnetic field intensity increases in the region between the first transmission portion 10A and the second transmission portion 10B where the directions of the magnetic fields are the same, the region between the two signal lines is very small, so the influence of the increased magnetic field intensity on the communication by wireless equipment located in the vicinity of the PLC signal line 10 is extremely small and almost negligible.

### Embodiment 2

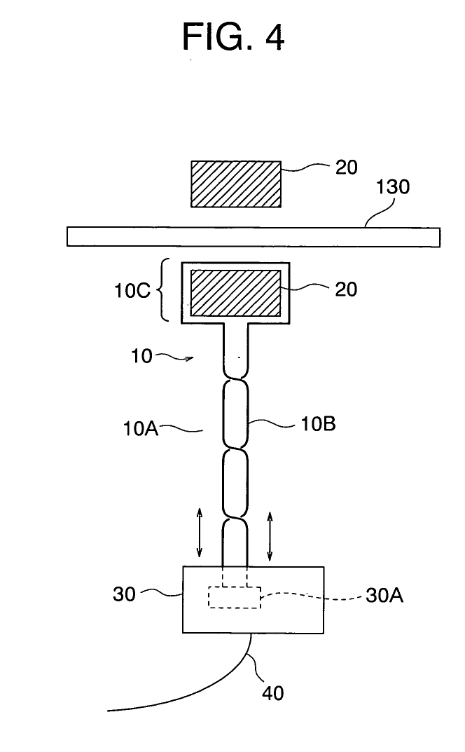

FIG. 4 is a diagram showing the wiring structure of a PLC signal line in a signal coupling device according to Embodiment 2 of the present invention, together with the sectional structures of the signal coupling device and power line.

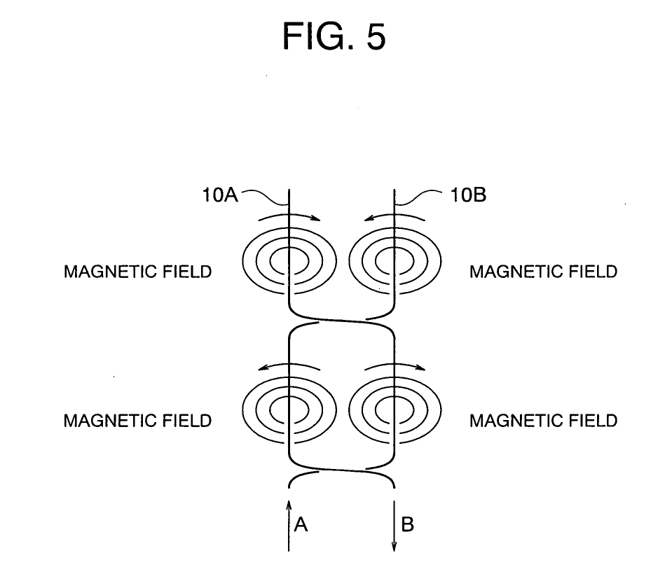

FIG. 5 is a diagram conceptually illustrating magnetic fields generated by the PLC signal line of the signal coupling device according to Embodiment 2 of the present invention. FIG. 5 shows the magnetic fields as generated when the directions of currents flowing in the first transmission portion 10A and in the second transmission portion 10B upon transmission of a PLC signal are as indicated by the arrows A and B, respectively.

The construction of the signal coupling device according to Embodiment 2 is similar to that of the signal coupling device according to Embodiment 1 except for the wiring structure of the PLC signal line 10.

As shown in FIG. 4, the first transmission portion 10A and second transmission portions 10B of the signal coupling device according to Embodiment 2 are bent in a rectangular shape at predetermined intervals, and their bent portions cross each other at predetermined intervals so that their linear portions are opposed to each other in a staggered fashion.

By forming the first transmission portion 10A and the second transmission portion 10B in this way, as shown in FIG. 5, the directions of the magnetic fields generated between the first transmission portion 10A and the second transmission portion 10B change for each predetermined section between the signal coupling member 20 and the PLC modem 30. The influences of the magnetic fields to the outside of the PLC signal line 10 are thus equalized, thereby making it possible to further mitigate their influence on the communication by the wireless equipment located in the vicinity of the PLC signal line 10.

While in the above description the first transmission portion 10A and the second transmission portion 10B used are bent in a rectangular shape at predetermined intervals and their bent portions cross each other at predetermined intervals so that their linear portions are opposed to each other in a staggered fashion, this should not be construed restrictively; the first transmission portion 10A and the second transmission portions 10B may not necessarily be bent in a rectangular shape but may be bent more gently. That is, the specific configuration of the first transmission portion 10A and second transmission portion 10B may be different from that described above as long as the first transmission portion 10A and the second transmission portion 10B cross each other at predetermined intervals so that the magnetic fields generated by them are canceled out.

### Embodiment 3

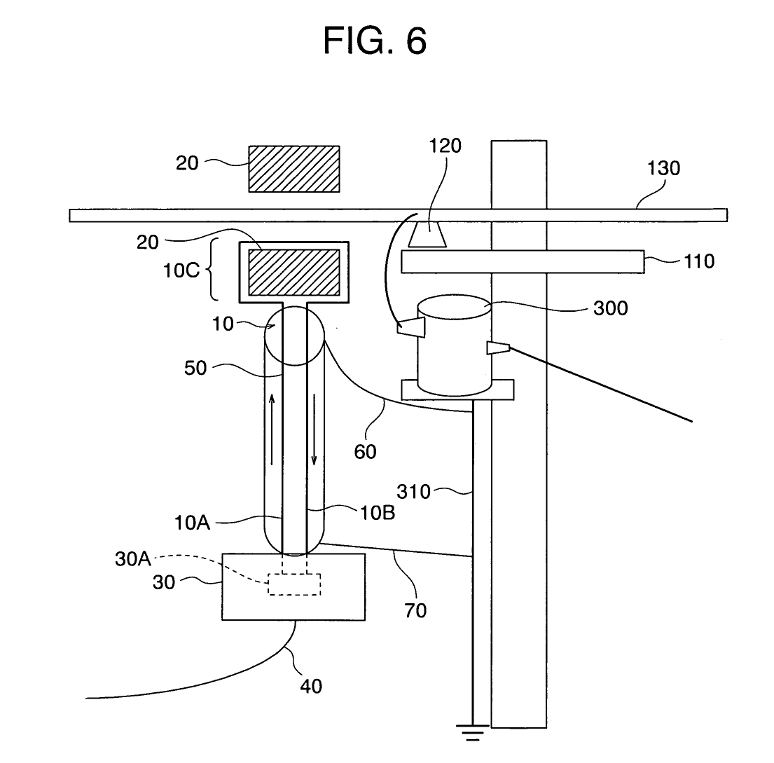

FIG. 6 is a diagram showing the wiring structure of a PLC signal line in a signal coupling device according to Embodiment 3 of the present invention, together with the sectional structures of the signal coupling device and power line.

As shown in FIG. 6, the signal coupling device according to Embodiment 3 of the present invention includes a magnetic shield 50 covering the two parallel transmission portions, the first transmission portion 10A and the second transmission portion 10B. The opposite ends of the magnetic shield 50 are connected by connecting wires 60 and 70 to a ground wire 310 installed in a power distribution pole 100.

By covering the first transmission portion 10A and the second transmission portion 10B with the magnetic shield 50 that is grounded, it is possible to reduce the amount of magnetic fields leakage to the exterior without being canceled out between the first transmission portion 10A and the second transmission portion 10B extending parallel to each other. That is, a further improvement can be achieved in terms of the magnetism-shielding effect.

While the above description is directed to the case where the ground wire 310 for grounding a transformer 300 mounted to the power pole 100 is used to ground the magnetic shield 50 through the connecting wires 60 and 70, the method of grounding the magnetic shield 50 is not limited there to.

### Embodiment 4

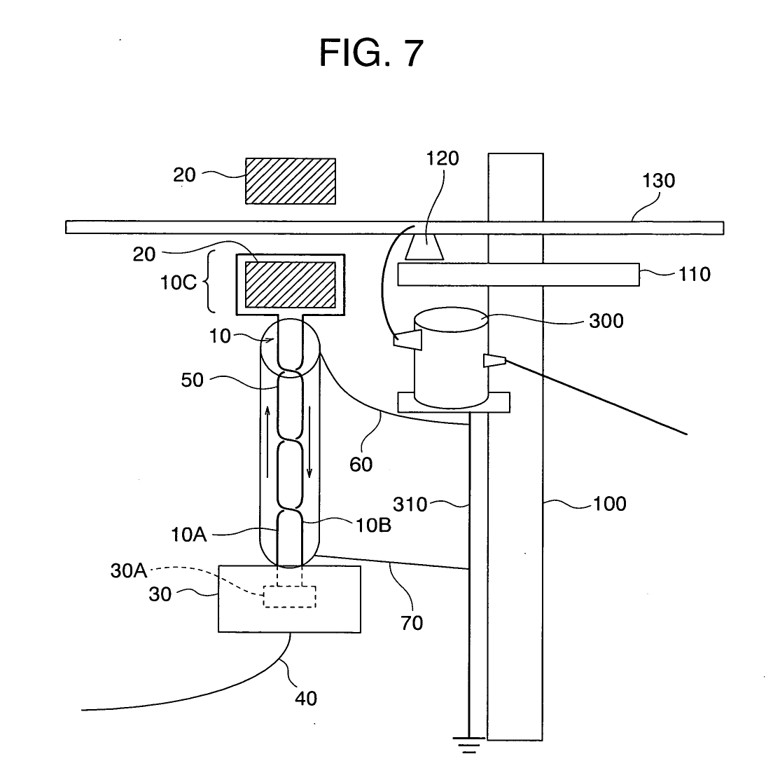

FIG. 7 is a diagram showing the wiring structure of a PLC signal line in a signal coupling device according to Embodiment 4 of the present invention, together with the sectional structures of the signal coupling device and power line.

The signal coupling device as shown in FIG. 7 is obtained by combining the structure of the first transmission portion 10A and second transmission portion 10B of the signal coupling device according to Embodiment 2 with the magnetic shield 50 of the signal coupling device according to Embodiment 3.

That is, the magnetic shield 50 is used to cover the first transmission portion 10A and the second transmission portion 10B, which are bent in a rectangular shape at predetermined intervals and whose bent portions cross each other at predetermined intervals so that their respective linear portions are opposed to each other in a staggered fashion. Therefore, it is possible to provide a signal coupling device with improved magnetism-shielding effect.

### Embodiment 5

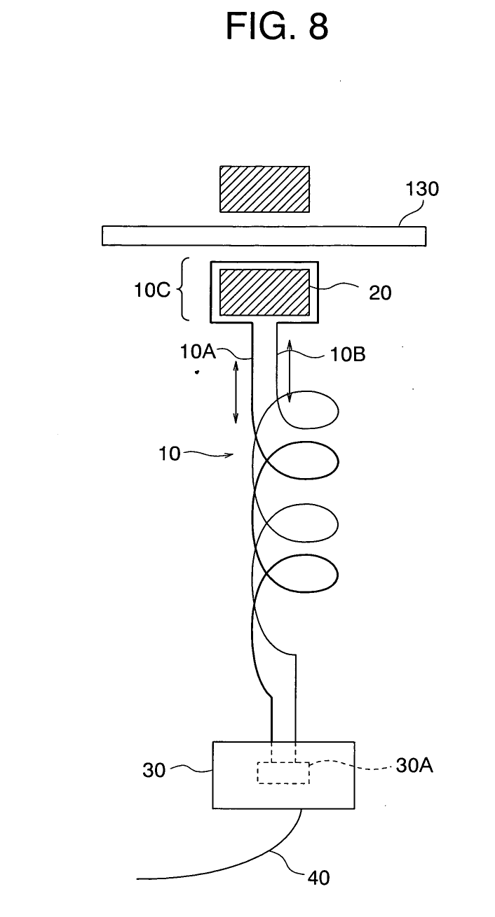

FIG. 8 is a diagram showing the wiring structure of a PLC signal line in a signal coupling device according to Embodiment 5 of the present invention, together with the sectional structures of the signal coupling device and power line.

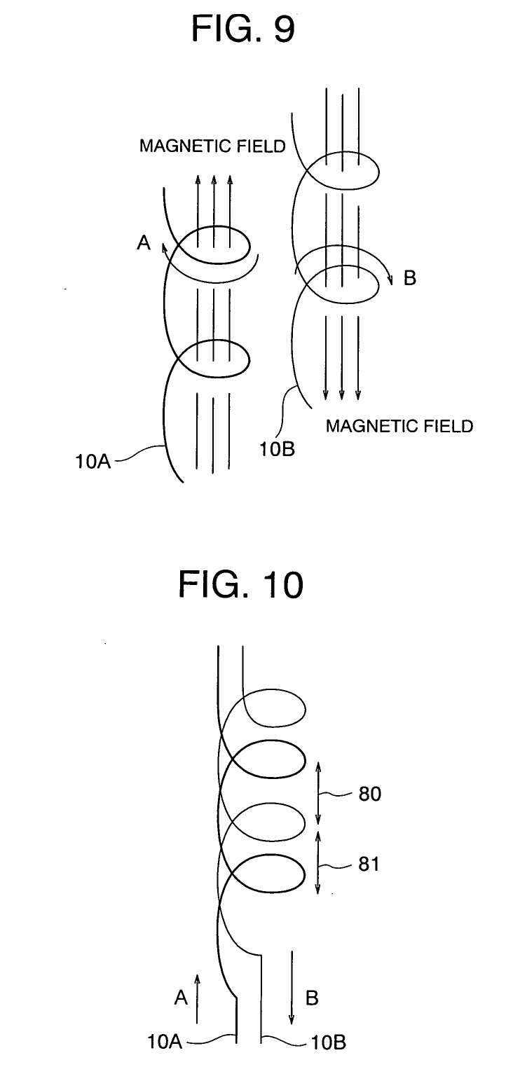

FIG. 9 is a diagram conceptually illustrating magnetic fields generated by the PLC signal line of the signal coupling device according to Embodiment 5 of the present invention. FIG. 9 shows the magnetic fields as generated when the directions of currents flowing in the first transmission portion 10A and in the second transmission portion 10B upon transmission of a PLC signal are as indicated by the arrows A and B, respectively.

As shown in FIG. 8, the first transmission portion 10A and second transmission portion 10B of the signal coupling device according to Embodiment 5 of the present invention are each wound in the form of a spiral and are arranged so that the turn portions of their respective spirals overlap each other. The construction of the signal coupling device according to Embodiment 5 is similar to that of the signal coupling device according to Embodiment 1 except for the configuration of the first transmission portion 10A and second transmission portion 10B.

As described above, the first transmission portion 10A and the second transmission portion 10B, which are each wound in the form of a spiral, are arranged so that their respective turn portions overlap each other. Accordingly, as shown in FIG. 9, the magnetic fields generated by the first transmission portion 10A and by the second transmission portion 10B act in opposite directions with respect to the direction of the center axis of the spiral.

As a result, when the respective center axes of the spirals of the first transmission portion 10A and second transmission portion 10B are aligned with each other, the magnetic fields generated by the first transmission portion 10A and by the second transmission portion 10B cancel each other.

Accordingly, the amount of magnetic field leakage to the outside of the spiral region of the PLC signal line 10 can be reduced, thereby making it possible to provide a signal coupling device with an extremely high magnetism-shielding effect.

It should be noted that a signal coupling device with a high magnetism-shielding effect can be provided even when the center axes of the spirals of the first transmission portion 10A and second transmission portion 10B are slightly misaligned or when the diameters of their respective spirals are different from each other since most of the magnetic fields are canceled out by each other.

### Embodiment 6

FIG. 10 is a diagram conceptually illustrating magnetic fields generated by a PLC signal line of a signal coupling device according to Embodiment 6 of the present invention. FIG. 10 shows the magnetic fields as generated when the directions of currents flowing in the first transmission portion 10A and in the second transmission portion 10B upon transmission of the PLC signal are as indicated by the arrows A and B, respectively.

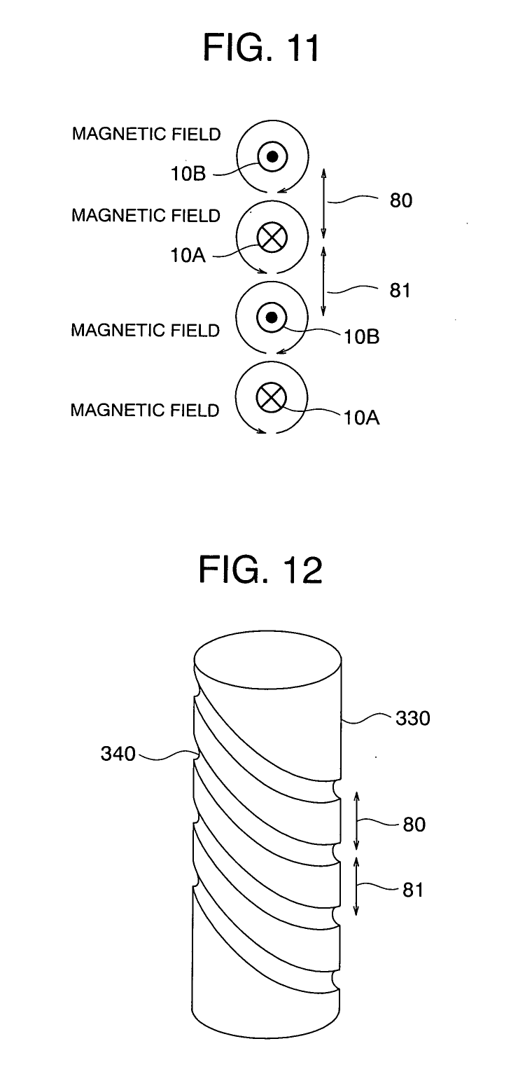

FIG. 11 is a sectional diagram conceptually illustrating the magnetic fields generated by the PLC signal line of the signal coupling device according to Embodiment 6 of the present invention.

The construction of the signal coupling device according to Embodiment 6 of the present invention is basically similar to that of the signal coupling device according to Embodiment 5, except that the spacings between the turn portions of the respective spirals of the first transmission portion 10A and second transmission portion 10B are the same and constant.

When the spiral configuration of the first transmission portion 10A and second transmission portion 10B is set as described above, as shown in FIG. 11, as seen in the cross sections of the spirals of the first transmission portion 10A and second transmission portion 10B in which currents flow in mutually opposite directions, the magnetic fields generated act in opposite directions.

By arranging the first transmission portion 10A and the second transmission portion 10B so that the spacings between adjacent turning portions of the first transmission portion 10A and second transmission portion 10B are the same and constant, that is, by setting a spiral winding spacing 80 and a spiral winding spacing 81 to be the same and constant, it is possible to further reduce the amount of magnetic field leaking from in between the first transmission portion 10A and the second transmission portion 10B which are spirally wound. Accordingly, the amount of magnetic field leakage to the outside of the spiral regions of the first transmission portion 10A and second transmission portion 10B can be reduced, thereby making it possible to provide a signal coupling device with an extremely high magnetism-shielding effect.

### Embodiment 7

FIG. 12 is a diagram schematically showing the structure of a holder for holding a PLC signal line of a signal coupling device according to Embodiment 7 of the present invention.

The signal coupling device according to Embodiment 7 includes a holder 330 for holding the first transmission portion 10A and the second transmission portion 10B in a spiral fashion. Otherwise, the construction of Embodiment 7 is similar to that of Embodiment 6.

Formed in the outer peripheral side surface of the holder 330, which has a cylindrical configuration, are grooves 340A and 340B into which the first transmission portion 10A and the second transmission portions 10B are fitted.

The grooves 340A and 340B are two spiral grooves formed in parallel at the same constant spacing along the longitudinal direction of the outer peripheral side surface of the holder 330.

By using the holder 330 provided with the grooves 340A and 340B as described above, it is possible to arrange the first transmission portion 10A and the second transmission portion 10B in the same manner as in Embodiment 6.

Moreover, the first transmission portion 10A and the second transmission portion 10B are fixed in position by the holder 330, so the spiral configuration of the first transmission portion 10A and second transmission portion 10B can be maintained in a stable manner over a long period of time, thereby preventing deformation due to disturbances.

As a result, the leakage of magnetic field to the outside of the spiral regions of the first transmission portion 10A and second transmission portion 10B can be suppressed, thereby making it possible to provide a signal coupling device with an enhanced magnetism-shielding effect.

It should be noted that the holder 330 can be reduced in weight by making it hollow.

Further, while in the case of the holder 330 described above the spacings (the spiral winding spacing 80 and the spiral winding spacing 81) between the grooves 340A and 340B are the same and constant in order to hold the first transmission portion 10A and the second transmission portion 10B in the manner of parallel spirals at the same constant spacing, the spacings between the grooves 340A and 340B may not necessarily be the same and constant. In particular, design modifications may be made to the spacings as appropriate according to the magnetic field characteristics and the like.

### Embodiment 8

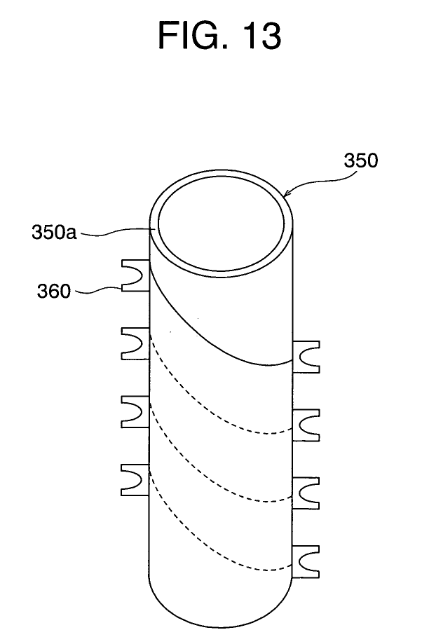

FIGS. 13 through 15 are diagrams schematically showing the structure and main portions of a holder for holding a PLC signal line of a signal coupling device according to Embodiment 8 of the present invention.

The signal coupling device according to Embodiment 8 of the present invention includes a holder 350 as shown in FIG. 13. The holder 350 includes fastening members 360 for holding the first transmission portion 10A and the second transmission portion 10B in a spiral fashion along the outer peripheral side surface of a cylindrical member 350a. The fastening members 360 each consist of a U-shaped flexible member and are arranged at a constant spacing on the outer peripheral side surface of a cylindrical member 350a.

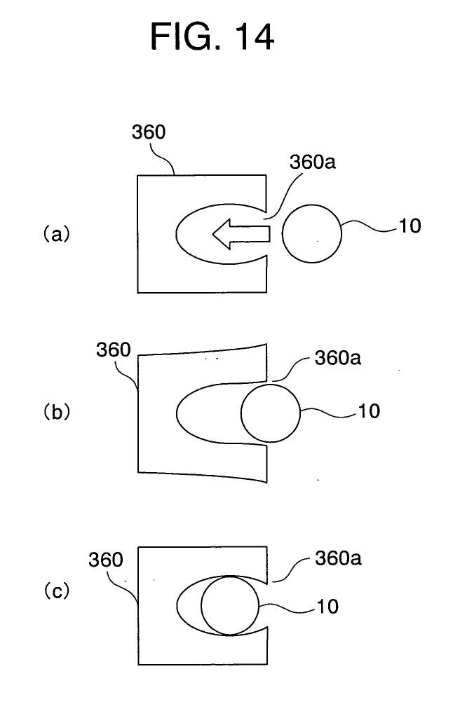

As shown in FIG. 14A, the width of an opening 360a of each U-shaped fastening member 360 is set to be smaller than the diameter of the PLC signal line 10. Accordingly, to fit the PLC signal line 10 into each fastening member 360, the opening of the fastening member 360 is laterally enlarged as shown in FIG. 14B, and then the PLC signal line 10 is held by the fastening member 360 as shown in FIG. 14C.

By using the holder 350 provided with the fastening members 360 as described above, in the same manner as in Embodiment 7, the spiral configuration of the first transmission portion 1A and second transmission portion 10B can be maintained in a stable manner over a long period of time, thereby making it possible to prevent deformation due to disturbances.

As a result, the leakage of magnetic field to the outside of the spiral regions of the first transmission portion 10A and second transmission portion 10B can be suppressed, thereby making it possible to provide a signal coupling device with an enhanced magnetism-shielding effect.

Since, in particular, the structure of the holder 350 is simple, the holder 350 can be easily manufactured at low cost.

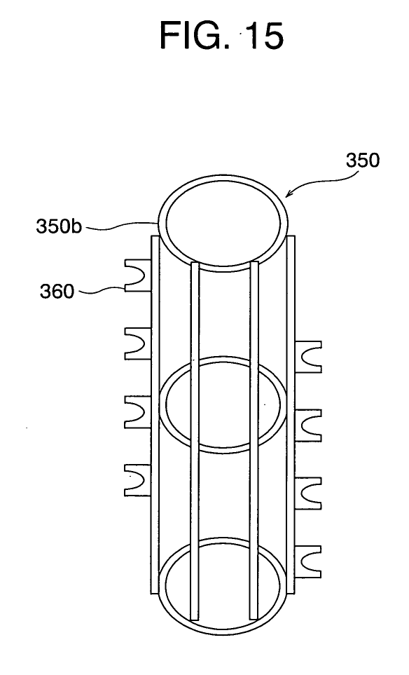

It should be noted that a cylindrical assembly 350b as shown in FIG. 15 may be used instead of the cylindrical member 350a. The holder 350 employing the cylindrical assembly 350b can be made more lightweight than the holder 350 employing the cylindrical member 350a and, in particular, the performance of the signal coupling device becomes relatively unaffected by disturbances such as wind.

While the foregoing description is directed to the holder 350 equipped with the fastening members 360 for holding the first transmission portion 10A and the second transmission portion 10B in a parallel, spiral fashion at the same constant spacing, the fastening members 360 may not necessarily be arranged at the same constant spacing. In particular, design modifications may be made to the spacing as appropriate according to the magnetic field characteristics and the like.

### Embodiment 9

The construction of a signal coupling device according to Embodiment 9 of the present invention is basically similar to that of the signal coupling device according to each of Embodiments 7 and 8, except that the holder 330 or the holder 350 is formed of a material having electrical insulation properties.

By providing the signal coupling device with the holder 330 or 350 formed of an insulating material as described above, the insulation properties between the signal coupling member 20 and the PLC modem 30 can be improved, whereby an improvement can be achieved in terms of the safety of the signal coupling device.

What is claimed is:

1. A signal coupling device comprising:
a signal coupling member having a hollow portion through which a power line penetrates; and
a signal line covered with an insulating coating, the signal line having a penetrating portion that penetrates through the hollow portion, and a first transmission portion and a second transmission portion which extend from the penetrating portion,
wherein the first transmission portion and the second transmission portion are arranged at a predetermined spacing from each other.

2. A signal coupling device according to claim 1, wherein the first transmission portion and the second transmission portion have a region in which the first transmission portion and the second transmission portion are arranged in parallel with each other.

3. A signal coupling device according to claim 1, wherein the first transmission portion and the second transmission portion are each bent in a rectangular shape at predetermined intervals to form bent portions, and wherein the bent portions of the first transmission portion and the bent portions of the second transmission portion cross each other at predetermined intervals so that linear portions of the first transmission portion and second transmission portion are opposed to each other in a staggered fashion.

4. A signal coupling device according to claim 1, wherein the first transmission portion and the second transmission portion are each wound in a form of a spiral so that turn portions of the spiral of the first transmission portion and turn portions of the spiral of the second transmission portion overlap each other.

5. A signal coupling device according to claim 4, wherein the first transmission portion and the second transmission portion are arranged so that a center axis of the spiral of the first transmission portion and a center axis of the spiral of the second transmission portion are aligned with each other.

6. A signal coupling device according to claim 4, wherein the first transmission portion and the second transmission portion are arranged so that spacing between adjacent turn portions of the first transmission portion and second transmission portion are the same and constant.

7. A signal coupling device according to claim 4, further comprising a holder for winding each of the first transmission portion and the second transmission portion in the form of the spiral.

8. A signal coupling device according to claim 7, wherein the holder is cylindrical in shape and has in an outer peripheral surface of the holder grooves into which the first transmission portion and the second transmission portion are fitted respectively.

9. A signal coupling device according to claim 7, wherein the holder has on a side surface of the holder fastening members for fastening the first transmission portion and the second transmission portion respectively.

10. A signal coupling device according to claim 1, further comprising a magnetic shield covering at least a part of each of the first transmission portion and the second transmission portion.
